(19) United States
(12) Patent Application Publication
(10) Pub. No.: US 2008/0012834 A1
(43) Pub. Date: Jan. 17, 2008

(54) KEY BUTTON USING LCD WINDOW

(75) Inventor: Heung-Sik SHIN, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/776,213

(22) Filed: Jul. 11, 2007

(30) Foreign Application Priority Data
Jul. 12, 2006 (KR) 2006-0065217

(51) Int. Cl. G06F 3/041; G06F 5/00

(52) U.S. Cl. 345/173; 345/156

(57) ABSTRACT

Provided is a key button of an electronic device including a liquid crystal display (LCD) module. The key button includes a case frame having an opening for displaying, wherein the opening is formed in a position in which an LCD module is installed; an LCD window formed of a transparent material to be installed in the opening of the case frame so as to close the opening and move in a predetermined direction; and switching devices installed in the case frame to perform corresponding functions according to the movement of the LCD window.

### PRIORITY

This application claims priority under 35 U.S.C. § 119 to an application filed in the Korean Intellectual Property Office on Jul. 12, 2006 and assigned Serial No. 2006-65217, the contents of which are incorporated herein by reference.

### BACKGROUND OF THE INVENTION

1. Field of the Invention

The present invention relates generally to a key button which may be installed in various types of electronic devices having Liquid Crystal Display (LCD) modules, and in particular, to a key button using an LCD window, which is installed above an LCD module to protect the LCD module.

2. Description of the Related Art

In general, various types of electronic devices, in particular, portable electronic devices, each includes a plurality of key buttons as input units to operate as units for inputting data such as characters, figures, or the like. Studies have been made to appropriately dispose such key buttons in proper places of devices, which have been made compact and light, so that the key buttons can perform more functions. For example, a device such as an MP3 player, a portable terminal, or the like has a very small size, and a key button for performing a plurality of functions occupies a confined space. Thus, a space for installing the key button is much limited.

A display device is installed in an electronic device as described above. A Liquid Crystal Display (LCD) module is mounted on a main board of the electronic device. Also, an open space is formed in a case frame so that a user displays input data, etc. through the open space. Here, an LCD window formed of a transparent material is installed in the open space of the case frame to protect the LCD module and externally make the electronic device beautiful.

However, the LCD window is fixedly installed in the electronic device to only protect the LCD module. Thus, the LCD window operates solely as a single-purpose fixed device in a slim electronic device which has been made compact and light and is required to offer a plurality of functions.

### SUMMARY OF THE INVENTION

An aspect of the present invention is to substantially solve at least the above problems and/or disadvantages and to provide at least the advantages below. Accordingly, an aspect of the present invention is to provide a key button using a liquid crystal display (LCD) window which protects an LCD module and performs a key button function.

Another aspect of the present invention is to provide a key button using an LCD window which performs a key button function to exclude a replaceable key button so as to reduce a bulk of an electronic device.

According to one aspect of the present invention, there is provided a key button of an electronic device including a liquid crystal display (LCD) module. The key button includes a case frame having an opening for displaying, wherein the opening is formed in a position in which an LCD module is installed; an LCD window formed of a transparent material to be installed in the opening of the case frame so as to close the opening and move in a predetermined direction; and switching devices installed in the case frame to perform functions corresponding to movements of the LCD window.

### BRIEF DESCRIPTION OF THE DRAWINGS

The above and other aspects, features and advantages of the present invention will become more apparent from the following detailed description when taken in conjunction with the accompanying drawings in which:

FIG. 1 is a perspective view of a portable terminal having a key button using a liquid crystal display (LCD) window according to the present invention;

FIG. 2 is a cross-sectional view illustrating important elements of the portable terminal of FIG. 1;

FIG. 3 is a perspective view of another portable terminal having a key button using an LCD window according to the present invention; and

FIG. 4 is a cross-sectional view illustrating important elements of the portable terminal of FIG. 3.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

The present invention provides a portable terminal in which a liquid crystal display (LCD) window is adopted. However, a key button using the LCD window may be applied to various types of electronic devices having LCD modules.

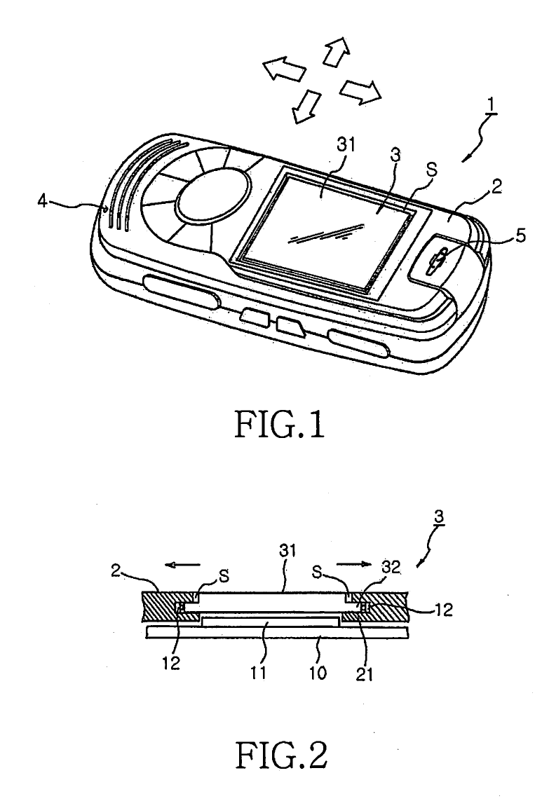

FIG. 1 is a perspective view of a portable terminal 1 having a key button 3 according to the present invention. Here, the key button 3 uses an LCD window 31 and is installed on a case frame 2 of a body. The LCD window 31 is formed of a transparent material and installed in the portable terminal to protect an LCD module 11 shown in FIG. 2, externally makes the portable terminal 1, and performs a key button function.

A microphone 4 is installed in a lower portion of the portable terminal 1, and a speakerphone 5 is installed above the key button 3 in order to realize a handset.

The LCD window 31 may be installed in a rectangular shape so as to move in directions of four edges thereof, i.e., directions indicated by the four arrows in FIG. 1. Here, the LCD window 31 may be installed so that the four edges thereof keep a predetermined distance S from the case frame 2 of the portable terminal 1, so as to be restored to an original position in normal times or after an operation thereof.

FIG. 2 is a cross-sectional view illustrating important elements of the portable terminal 1 of FIG. 1. Guide ribs 32 respectively extend from the four edges of the LCD window 31 to predetermined thicknesses. The guide ribs 32 are stably placed into guide slits 21 formed in the case frame 2 of the portable terminal 1 so as to be guided in left, right, forward, and backward directions. Switching devices 12 are installed in the guide slits 21 to support ends of the guide slits 21 and perform switching operations according to movements of the guide ribs 32. The switching devices 12 may be well-known tact switches, metal dome switches, or the like. A main board 10 of the portable terminal 1 and an LCD module 11 may be installed under the LCD window 31. Here, the LCD module 11 may be mounted on the main board 10.

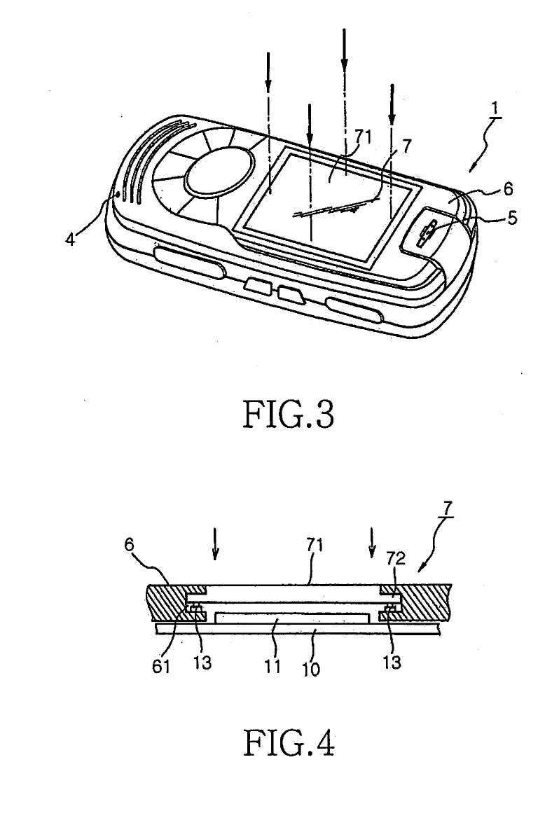

FIG. 3 is a perspective view of portable terminal having a key button 7 using an LCD window 71 according to the present invention. Referring to FIG. 3, a speakerphone 5 is installed in an upper portion of a portable terminal 1, and a microphone 4 is installed in a lower portion of the portable terminal 1. The portable terminal 1 also includes the key button 7 using the LCD window 71. Differently from the LCD window 31 of FIG. 1, four edges of the LCD window 71 are pressed in a vertical direction, i.e., a direction indicated by arrows in FIG. 3, so as to perform a switching operation.

FIG. 4 is a cross-sectional view illustrating important elements of the portable terminal 1 of FIG. 3. The LCD window 71 is formed in a rectangular shape, and pressure ribs 72 respectively extend the four edges of the LCD window 71 to predetermined thicknesses and lengths. The pressure ribs 72 are installed in support slits 61, which are formed in a case frame 6 of the portable terminal 1 to predetermined depths, to be supported in the support slits 61. Switching devices 13 are installed in the support slits 13, and the pressure ribs 72 are placed on the switching devices 13. Thus, if one or more of the four edges of the LCD window 71 are pressed, the switching devices 13 may operate. If the four edges of the LCD window 71 are released from being pressed, the LCD window 71 may constantly keep a horizontal state due to restoring forces of the switching devices 13.

Although not shown, an additional elastic member may be used so that the LCD window 31 constantly keeps the predetermined distance S from the case frame 2 or the LCD window 71 constantly keeps the horizontal state. In other words, springs may be interposed between the guide ribs 32 and the guide slits 21 of FIG. 2 or between the pressure ribs 72 and the support slits 61 of FIG. 4.

In accordance with the present invention as described above, a key button using an LCD window can provide a user with a new click method. Also, the key button can exclude an existing key button to utilize a space of a device and reduce a bulk of the device.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A key button for an electronic device having a Liquid Crystal Display (LCD) module, comprising:
a case frame having an opening for displaying, the opening receiving the LCD module;
an LCD window formed of a transparent material installed in the opening so as to close the opening and move in a predetermined direction; and
at least one switching device installed in the case frame to perform functions corresponding to movements of the LCD window.

2. The key button of claim 1, wherein the movements are in forward, backward, left, and right directions which are parallel with a front surface of the electronic device.

3. The key button of claim 2, wherein the LCD window is formed in a rectangular shape and comprises four edges at which guide ribs are formed to be guided and moved in guide slits formed around the opening.

4. The key button of claim 3, wherein the at least one switching device is installed in portions of the guide slits in which ends of the guide ribs are positioned so as to support the guide ribs.

5. The key button of claim 4, wherein the at least one switching device supports the guide ribs in the guide slits so as to keep a predetermined distance between the edges of the opening and the ends of the guide ribs when the LCD window is not moved.

6. The key button of claim 1, wherein the LCD window is formed in a rectangular shape, and approximately intermediate portions of four edges of the LCD window are pressed in a direction perpendicular to a front surface of the electronic device so as to perform a switching operation.

7. The key button of claim 6, wherein pressure ribs extend from the four edges of the LCD window to be supported in support slits formed around the opening.

8. The key button of claim 7, wherein the at least one switching device is installed in the support slits to support the pressure ribs.

9. The key button of claim 5, wherein the at least one switching device is one of a tact switch or a metal dome switch.

10. The key button of claim 8, wherein the at least one switching device is one of a tact switch and a metal dome switch.
